(19) United States
(12) Patent Application Publication
(10) Pub. No.: US 2026/0253928 A1
(43) Pub. Date: Aug. 27, 2026

(54) FUEL CELL SYSTEM

(71) Applicant: AISIN CORPORATION, Kariya (JP)

(72) Inventors: Akihiro TAJIKARA, Kariya-shi (JP); Taiga MURAKAMI, Kariya-shi (JP)

(73) Assignee: AISIN CORPORATION, Kariya (JP)

(21) Appl. No.: 19/545,645

(22) Filed: Feb. 20, 2026

(30) Foreign Application Priority Data
Feb. 27, 2025 (JP) 2025-029990

(51) Int. Cl. H01M 8/04746; H01M 8/04082; H01M 8/04537; H01M 8/0662

(52) U.S. Cl. CPC H01M 8/04753; H01M 8/04201; H01M 8/04552; H01M 8/0662

(57) ABSTRACT

A first fuel cell system of the present disclosure includes a power generation module including a fuel cell that generates power by receiving a supply of fuel, and a combustion unit that burns unused fuel that is not used in the fuel cell, a fuel supply system that is allowed to adjust a flow rate of fuel to be supplied to the fuel cell, a voltage sensor that detects a voltage of the fuel cell, and a control unit that monitors a voltage detected by the voltage sensor while increasing a fuel utilization rate by decreasing a flow rate of fuel supplied to the fuel cell in a state where a current taken out from the fuel cell is kept constant, and determines a set fuel utilization rate used for an operation of the fuel cell based on a decrease in the voltage detected by the voltage sensor at a rate exceeding a predetermined amount per unit time.

### CROSS REFERENCE TO RELATED APPLICATIONS

This application is based on and claims priority under 35 U.S.C. § 119 to Japanese Patent Application No. 2025-029990, filed on Feb. 27, 2025, the entire content of which is incorporated herein by reference.

### TECHNICAL FIELD

The present specification discloses a fuel cell system.

### BACKGROUND DISCUSSION

In the related art, as this type of the fuel cell system, there has been proposed a system that detects a stable state of a temperature of a predetermined portion of a cell stack, and diagnoses a deterioration state of the predetermined portion of the cell stack based on a change amount (change rate) of an output voltage of the cell stack when an output current of the cell stack, a supply amount of fuel gas, and a supply amount of oxidant gas are changed at a constant ratio during the stable state, or the output current of the cell stack is changed while the supply amount of fuel gas and the supply amount of oxidant gas are kept constant (see, for example, JP 2010-27580 A).

In the fuel cell system described above, although it is described that the deterioration state of the cell stack is diagnosed based on the change amount (change rate) of the output voltage of the cell stack, there is no mention of improving the efficiency of the system.

A need thus exists for a fuel cell system which is not susceptible to the drawback mentioned above.

### SUMMARY

The present disclosure uses the following means to achieve the above main object.

A first fuel cell system of the present disclosure includes a power generation module including a fuel cell that generates power by receiving a supply of fuel, and a combustion unit that burns unused fuel that is not used in the fuel cell, a fuel supply system that is allowed to adjust a flow rate of fuel to be supplied to the fuel cell, a voltage sensor that detects a voltage of the fuel cell, and a control unit that monitors a voltage detected by the voltage sensor while increasing a fuel utilization rate by decreasing a flow rate of fuel supplied to the fuel cell in a state where a current taken out from the fuel cell is kept constant, and determines a set fuel utilization rate used for an operation of the fuel cell based on a decrease in the voltage detected by the voltage sensor at a rate exceeding a predetermined amount per unit time.

A second fuel cell system of the present disclosure includes a power generation module including a fuel cell that generates power by receiving a supply of fuel, and a combustion unit that combusts unused fuel that is not used in the fuel cell, a fuel supply system that is allowed to adjust a flow rate of fuel supplied to the fuel cell, and a control unit that executes control to change a fuel utilization rate by changing the flow rate of the fuel supplied to the fuel cell, calculate power generation efficiency before and after a change in the fuel utilization rate, compare the power generation efficiency before and after the change, and cause a transition to a fuel utilization rate with a higher power generation efficiency.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration diagram of a fuel cell system according to the present embodiment;

FIG. 2 is a schematic configuration diagram of each power generation module and auxiliary machine included in the fuel cell system;

FIG. 3 is a schematic configuration diagram of a power generation module;

FIG. 4 is a flowchart illustrating an example of a fuel utilization rate adjustment control routine;

FIG. 5 is a flowchart illustrating an example of a fuel utilization rate adjustment control routine;

FIG. 6 is an explanatory diagram illustrating temporal changes of an output current, an output voltage, a fuel flow rate, and power generation efficiency when a set utilization rate is increased;

FIG. 7 is an explanatory diagram illustrating execution timing of efficiency determination;

FIG. 8 is an explanatory diagram illustrating a state in which an optimum set utilization rate is set by efficiency determination for each of the power generation modules HM1 and HM2; and

FIG. 9 is an explanatory diagram illustrating a relationship between a set utilization rate and power generation efficiency for each of the power generation modules HM1 and HM2.

### DETAILED DESCRIPTION

Embodiments for carrying out the present disclosure will be described with reference to the drawings.

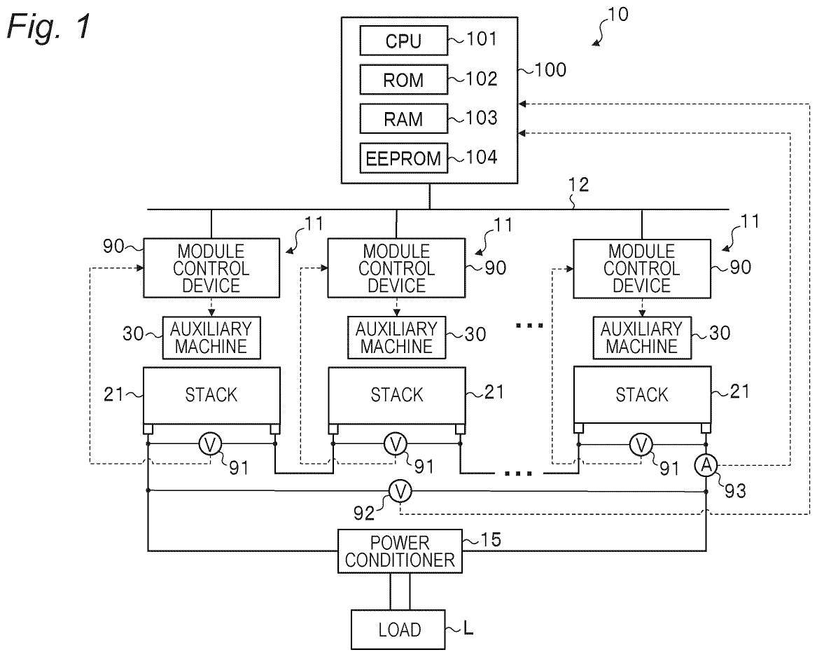

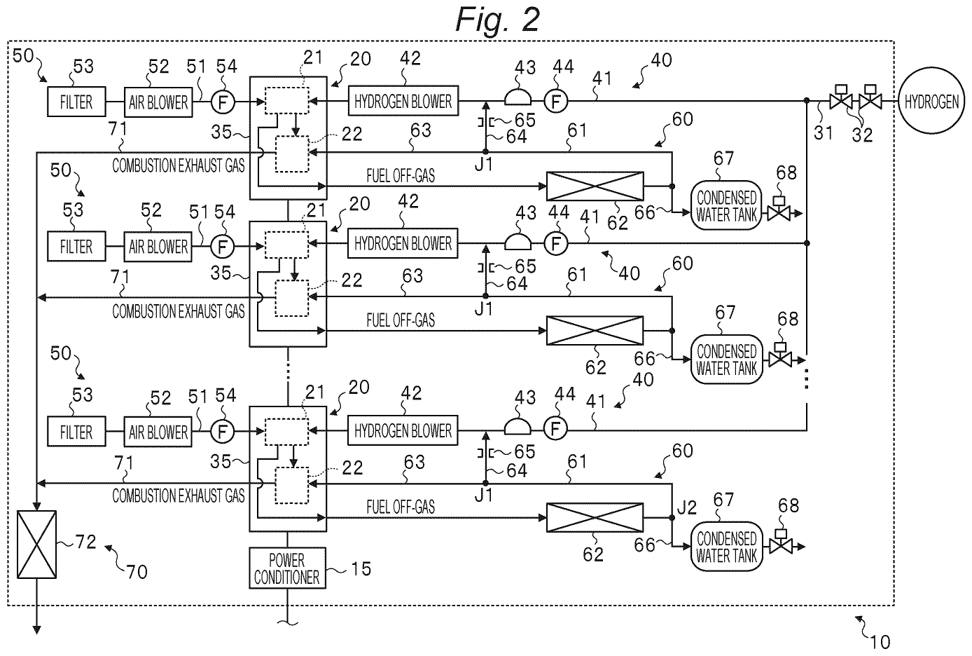

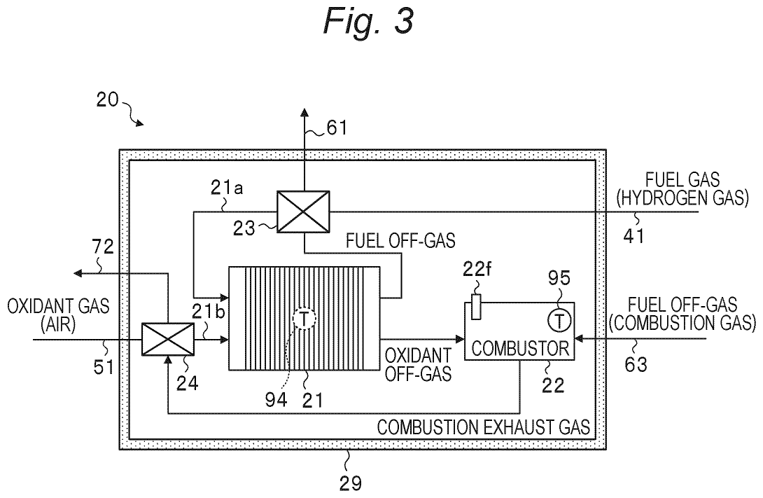

FIG. 1 is a schematic configuration diagram of a fuel cell system 10 according to the present embodiment, FIG. 2 is a schematic configuration diagram of a power generation module 20 and an auxiliary machine 30 included in fuel cell system 10, and FIG. 3 is a schematic configuration diagram of the power generation module 20.

As illustrated in FIG. 1, fuel cell system 10 of the embodiment includes a plurality of power generation units 11 and an integrated control device 100 that manages the plurality of power generation units 11.

As illustrated in FIG. 1, each of the plurality of power generation units 11 includes the power generation module 20 including a fuel cell stack 21, various auxiliary machines 30 necessary for operation of the fuel cell stack 21, and a module control device 90 that controls the various auxiliary machines 30.

As illustrated in FIG. 3, the power generation module 20 includes a combustor 22 and heat exchangers 23 and 24 in addition to the fuel cell stack 21, and these are accommodated in a module case 29 having a heat insulating property. As illustrated in FIG. 2, the various auxiliary machines 30 include a fuel supply system 40, an air supply system 50, a circulation system 60, an exhaust heat recovery system 70, and the like, and the fuel supply system 40, the air supply system 50, and the circulation system 60 are provided for each power generation module 20.

The fuel cell stack 21 includes a plurality of solid oxide unit cells each including an electrolyte, a fuel electrode disposed on one face of the electrolyte, and an oxidant electrode disposed on the other face of the electrolyte. Since the fuel cell stack 21 operates under a high-temperature environment of, for example, 600 to 800° C., the electrolyte, the fuel electrode, and the oxidant electrode are made of a ceramic material. In addition, a cermet of a metal such as nickel having a catalytic action and ceramics is used for the fuel electrode. Each fuel cell stack 21 generates power by a reaction between hydrogen contained in the fuel gas and oxygen contained in the oxidant gas. A temperature sensor 94 is disposed near the fuel cell stack 21. Temperature sensor 94 detects a temperature (stack temperature T4) correlated with the temperature of the fuel cell stack 21.

As shown in FIG. 3, a fuel gas supply pipe 21a is connected to a fuel electrode inlet of the fuel cell stack 21, and a heat exchanger 23 for exchanging heat of fuel gas flowing through fuel gas supply pipe 21a with fuel off-gas discharged from fuel cell stack 21 is installed at the fuel gas supply pipe 21a. An oxidant gas supply pipe 21b is connected to an oxidant electrode inlet of the fuel cell stack 21, and a heat exchanger 24 for exchanging heat of oxidant gas flowing through oxidant gas supply pipe 21b with combustion exhaust gas discharged from combustor 22 installed at the oxidant gas supply pipe 21b.

Hydrogen gas supplied as fuel gas by the fuel supply system 40 is introduced into the fuel electrode of the fuel cell stack 21 through the fuel gas supply pipe 21a, and air supplied as oxidant gas by the air supply system 50 is introduced into the oxidant electrode of the fuel cell stack 21 through the oxidant gas supply pipe 21b. Oxide ions (O²⁻) are generated at the oxidant electrode, and the oxide ions permeate the electrolyte and react with hydrogen at the fuel electrode, thereby obtaining electric energy. The fuel off-gas (residual fuel gas) that is not used for electrochemical reaction (power generation) in the fuel electrode of each unit cell exchanges heat with fuel gas (hydrogen gas) supplied from the fuel supply system 40 to the fuel electrode in the heat exchanger 23, and then is discharged to the outside of the module case 29. The fuel off-gas discharged to the outside of the module case 29 is supplied to the circulation system 60 through a fuel off-gas pipe 61, passes through the circulation system 60, and is then supplied to the combustor 22. The oxidant off-gas (residual oxidant gas) that is not used in the electrochemical reaction (power generation) at the oxidant electrode of each unit cell is directly supplied to the combustor 22. The fuel off-gas introduced into the combustor 22 is a combustible gas containing hydrogen, and is mixed with the oxidant off-gas containing oxygen introduced into the combustor 22, and the mixed gas is combusted in the combustor 22, whereby the fuel cell stack 21 is maintained at an appropriate temperature by combustion heat. The combustor 22 includes an ignition device 22f for igniting the mixed gas introduced into the combustor 22 in the activating process, and a temperature sensor 95 for detecting an internal temperature (combustion unit temperature T6) of the combustor 22. In the combustor 22, combustion exhaust gas is generated by combustion of the mixed gas, and the combustion exhaust gas exchanges heat with oxidant gas (air) supplied from the air supply system 50 to the oxidant electrode in the heat exchanger 24, and is then supplied to the exhaust heat recovery system 70 through a combustion exhaust gas pipe 71. The exhaust heat of the combustion exhaust gas is recovered by the exhaust heat recovery system 70, and then the combustion exhaust gas is discharged to the outside air.

Each fuel supply system 40 includes a branch pipe 41 that branches from the other end of a hydrogen supply pipe 31 having one end connected to a hydrogen supply source such as a hydrogen tank to the corresponding power generation module 20, and a hydrogen blower 42 installed at the branch pipe 41. By operating the hydrogen blower 42, hydrogen gas from the hydrogen supply source is pumped (supplied) to the power generation module 20 as fuel gas. Since the hydrogen blower 42 is installed at each branch pipe 41, the supply amount of the fuel gas can be controlled for each power generation module 20 by individually controlling each hydrogen blower 42. An on-off valve 32 (dual valve), a negative pressure preventing valve (not illustrated), and the like are installed at the hydrogen supply pipe 31, and a governor 43 (pressure equalizing valve), a fuel flow meter 44, and the like are installed at each branch pipe 41 in addition to the hydrogen blower 42. The fuel flow meter 44 detects a flow rate (fuel flow rate Fg) per unit time of the fuel gas flowing through the branch pipe 41. The fuel gas introduced into the power generation module 20 is heated by heat exchange with the fuel off-gas in heat exchanger 23, and then supplied to the fuel electrode of the fuel cell stack 21.

Each air supply system 50 includes an air supply pipe 51 connected to the corresponding power generation module 20, a filter 53 provided at the inlet of the air supply pipe 51, and an air blower 52 installed at the air supply pipe 51. By operating the air blower 52, air is sucked from the filter 53 and the sucked air is pumped (supplied) to the power generation module 20 as oxidant gas. Since the air blower 52 is installed at each air supply pipe 51, the supply amount of air can be controlled for each power generation module 20 by individually controlling each air blower 52. An air flow meter 54 is installed at each air supply pipe 51. The air flow meter 54 detects a flow rate (air flow rate Fa) per unit time of the air flowing through the air supply pipe 51. The air introduced into the power generation module 20 is heated by heat exchange with the combustion exhaust gas in the heat exchanger 24, and then supplied to the oxidant electrode of the fuel cell stack 21.

Each circulation system 60 includes a fuel off-gas pipe 61 connected to the corresponding power generation module 20, a condenser 62 installed at the fuel off-gas pipe 61, and a combustion gas pipe 63 branched from downstream of the condenser 62 in the fuel off-gas pipe 61 and connected to the combustor 22 of the corresponding power generation module 20. Further, the circulation system 60 also includes a reflux pipe 64 that branches from downstream of the condenser 62 in the fuel off-gas pipe 61 and is connected between the hydrogen blower 42 and the governor 43 at the corresponding branch pipe 41, and an orifice 65 formed in the reflux pipe 64.

The fuel off-gas discharged from the fuel electrode outlet of the fuel cell stack 21 of the corresponding power generation module 20 passes through the fuel off-gas pipe 61, and steam contained in the fuel off-gas is condensed by heat exchange with cooling water in the condenser 62. The fuel off-gas that has passed through the condenser 62 is distributed to the combustion gas pipe 63 and the reflux pipe 64. The fuel off-gas distributed to the combustion gas pipe 63 is supplied to the combustor 22 of the corresponding power generation module 20. On the other hand, the fuel off-gas distributed to the reflux pipe 64 is sucked into the branch pipe 41 by the negative pressure generated by the operation of the hydrogen blower 42, introduced into the power generation module 20, and supplied to the fuel electrode of the fuel cell stack 21. Although the orifice 65 is formed in the reflux pipe 64, a solenoid valve may be provided instead of the orifice 65.

The condensed water obtained by condensing the steam in each condenser 62 is stored in a condensed water tank 67 through a condensed water pipe 66 branched from the fuel off-gas pipe 61. A drain valve 68 is attached to the condensed water tank 67, and condensed water stored in the condensed water tank 67 is discharged to the outside through the drain valve 68.

The exhaust heat recovery system 70 includes a heat exchanger 72 connected to each of the combustion exhaust gas pipes 71. The heat of the combustion exhaust gas is recovered by heat exchange with the heat exchange medium in the heat exchanger 72, and the recovered heat is supplied to a heat utilizing device installed in a factory or the like.

The fuel cell stacks 21 of the respective power generation modules 20 are connected in series to a single power conditioner 15, and the DC power generated in each fuel cell stack 21 is converted by the power conditioner 15 and supplied to a load L. A voltage sensor 91 for detecting an output voltage of the fuel cell stack 21 is attached between output terminals of the fuel cell stacks 21 of the power generation modules 20. A voltage sensor 92 for detecting a voltage (total voltage Vt) of the whole of the fuel cell stacks 21 is mounted between one terminal (fuel electrode terminal) of the fuel cell stack 21 disposed at one end among fuel cell stacks 21 connected in series and the other terminal (oxidant electrode terminal) of the fuel cell stack 21 disposed at the other end. A current sensor 93 that detects a current flowing through the power line is attached to the power line connecting the fuel cell stacks 21 in series.

Power conditioner 15 includes a DC/DC converter and an inverter, converts DC power from each fuel cell stack 21 into AC power of a voltage (for example, AC200 V) communicable with a system power supply, and outputs the AC power. A power supply board (not illustrated) is connected to the power conditioner 15. The power supply board converts power from each fuel cell stack 21 into DC power of a voltage suitable for driving the various auxiliary machines 30, the module control device 90, and the integrated control device 100, and supplies the DC power to each of them. A cooling fan and a ventilation fan (not illustrated) for cooling the power conditioner 15 and the power supply board are installed in an auxiliary machine room in which the power conditioner 15, the power supply board, and the like are disposed.

Although not illustrated, each module control device 90 is configured as a microprocessor centered on a CPU, and includes a ROM for storing a processing program, a RAM for temporarily storing data, an EEPROM as a nonvolatile memory, an input/output port, and a communication port in addition to the CPU. A stack temperature T4 from the temperature sensor 94 installed in the vicinity of the fuel cell stack 21 of the corresponding power generation module 20, a combustion unit temperature T6 from the temperature sensor 95 installed in the combustor 22 of the corresponding power generation module 20, an output voltage V from the voltage sensor 91 attached between the output terminals of the fuel cell stacks 21 of the corresponding power generation modules 20, a fuel flow rate Fg from the fuel flow meter 44 installed at the branch pipe 41 of the corresponding fuel supply system 40, an air flow rate Fa from the air flow meter 54 installed at the air supply pipe 51 of the corresponding air supply system 50, and the like are input to each module control device 90 via the input port. In addition, a control signal to the hydrogen blower 42 of the corresponding fuel supply system 40, a control signal to the air blower 52 of the corresponding air supply system 50, and the like are output from each module control device 90 via an output port.

The integrated control device 100 is configured as a microprocessor centered on the CPU 101, and includes a ROM 102 for storing a processing program, a RAM 103 for temporarily storing data, an EEPROM 104 as a nonvolatile memory, a timer (not illustrated), an input/output port, and a communication port (not illustrated) in addition to the CPU 101. A total voltage Vt detected by the voltage sensor 92, an output current I from the current sensor 93, and the like are input to the integrated control device 100 via an input port. Further, a control signal to the power conditioner 15 (DC/DC converter, inverter), a control signal to the on-off valve 32, and the like are output from the integrated control device 100 through the output port. In addition, the integrated control device 100 is communicably connected to each module control device 90 via a communication bus 12, and exchanges control signals and data with each other.

Next, an operation of the fuel cell system 10 configured as described above according to the present embodiment will be described. When the activating of the fuel cell system 10 is requested from the host system, each module control device 90 performs the activating process according to the instruction from the integrated control device 100. In the activating process, each module control device 90 sequentially controls the auxiliary machine 30 to execute the purge process and the like of the combustor 22, then supplies fuel gas (hydrogen gas) and air to the combustor 22, and executes the warm-up process of warming up the fuel cell stack 21 by burning the fuel gas in the combustor 22. When warm-up of each fuel cell stack 21 is completed and each fuel cell stack reaches the power-generatable state, each module control device 90 shifts to the power generation process. As described above, the fuel cell stacks 21 of power generation modules 20 are connected in series to the load L, and the current flows through all fuel cell stacks 21 by the start of the current sweep. Therefore, each module control device 90 is required to simultaneously start the power generation process of the fuel cell stack 21. Therefore, the transition to the power generation process is performed by an instruction from the integrated control device 100 after the integrated control device 100 confirms that all the fuel cell stacks 21 have completed the warm-up and reached the power generatable state.

The integrated control device 100 sets a target current Itag based on required power required for the system, instructs each module control device 90 to perform the power generation process based on the target current Itag, and controls the power conditioner 15 so that a current corresponding to the target current Itag is taken out from each fuel cell stack 21. Each module control device 90 controls the fuel flow rate and the air flow rate based on the target current Itag. Specifically, the fuel flow rate is controlled by setting, as a target fuel flow rate Fgtag, a flow rate obtained by multiplying a fuel flow rate necessary for outputting the target current Itag by a reciprocal of a fuel utilization rate (obtained by converting the set utilization rate Uf into a decimal), and controlling a fuel pump 35 by feedback control so that the fuel flow rate Fg detected by a fuel flow meter 38 matches the target fuel flow rate Fgtag. The fuel utilization rate is a ratio of the amount of fuel used for power generation to the amount of fuel supplied to the fuel electrode. The set utilization rate Uf is individually set in each module control device 90. The air flow rate is controlled by setting, as a target air flow rate Fatag, a flow rate obtained by multiplying an air flow rate necessary for a reaction with fuel in the fuel cell stack 21 by a reciprocal of an air utilization rate Ua (decimal conversion), and controlling an air pump 53 by feedback control so that the air flow rate Fa detected by the air flow meter 54 matches the target air flow rate Fatag. The air utilization rate Ua is a ratio of the amount of air used for power generation to the amount of air supplied to the oxidant electrode.

When stop of the system is requested during the power generation process, each module control device 90 performs a stop process according to an instruction from the integrated control device 100. In the stop process, each module control device 90 controls the hydrogen blower 42 so that the fuel gas is supplied at a flow rate that does not cause oxidation degradation of the electrode of the fuel cell stack 21, and controls the air blower 52 so that air is supplied at a flow rate necessary for cooling the fuel cell stack 21. Then, when the stack temperature T4 from the temperature sensor 94 decreases to a temperature lower than the predetermined temperature, each module control device 90 stops the supply of the fuel gas and the air.

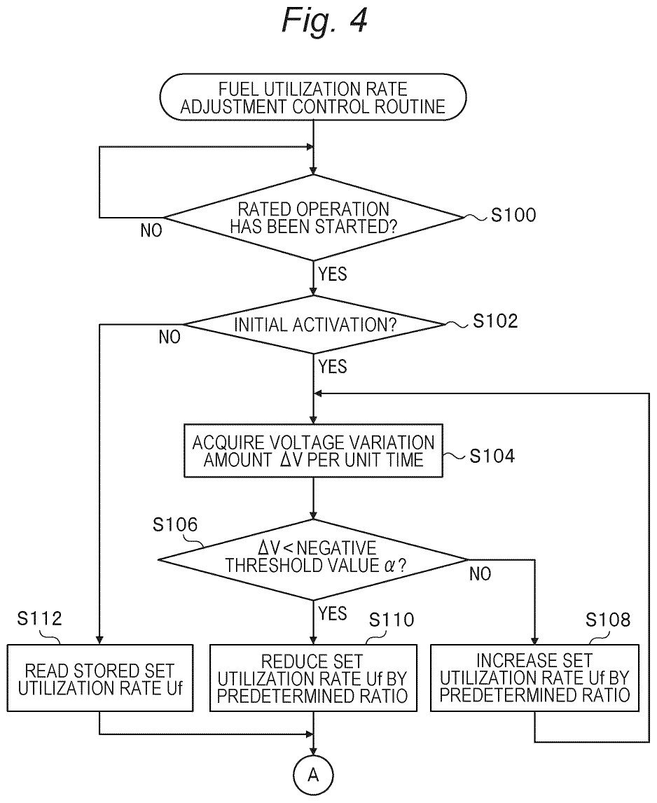

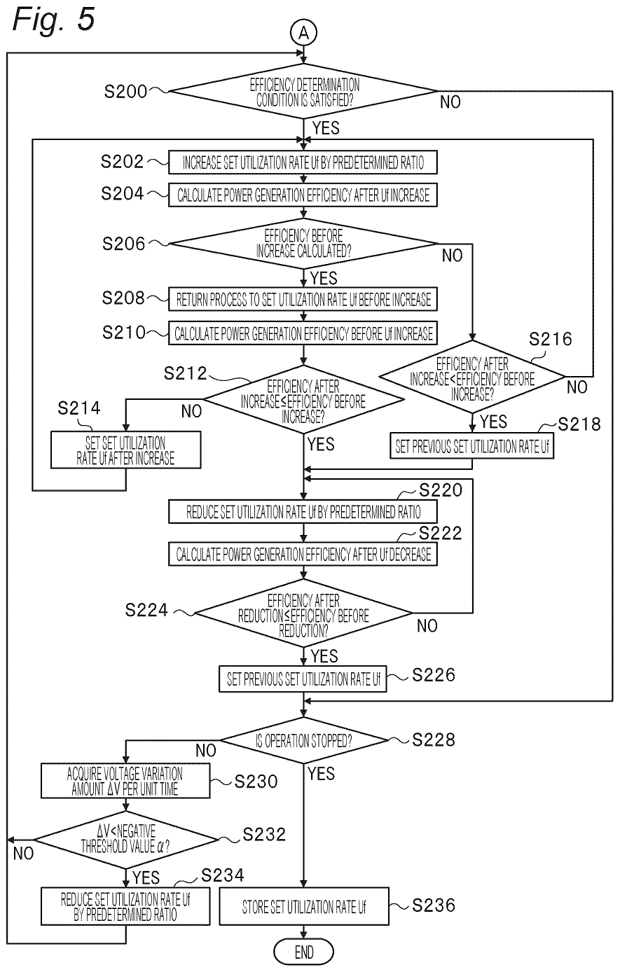

Next, processing for adjusting the fuel utilization rate will be described. FIGS. 4 and 5 are flowcharts illustrating an example of a fuel utilization rate adjustment control routine. This routine is executed for each module control device 90 after the system is activated.

When the fuel utilization rate adjustment control routine is executed, each module control device 90 (CPU) first waits for the start of the rated operation after activation (step S100). When the rated operation is started, the integrated control device 100 (CPU 101) controls the power conditioner 15 (DC/DC converter, inverter) so that the current taken out from each fuel cell stack 21 is constant. When determining that the rated operation is activated after the activation, each module control device 90 determines whether the current activation is the first time (step S102).

When determining that the current activation is the first activation, each module control device 90 acquires the variation amount (voltage variation amount ΔV) per unit time (for example, 300 sec) of the output voltage V detected by the voltage sensor 91 (step S104), and determines whether the acquired voltage variation amount ΔV is less than a negative threshold value α (step S106). Here, the threshold value α is a threshold value for determining whether a shortage occurs in the supply of fuel (hydrogen) to the fuel cell stack 21, and is determined in advance by experiment, analysis, or the like. Since the threshold value α is a negative value, the determination as to whether the voltage variation amount ΔV is less than the threshold value α is to determine whether the output voltage V has decreased by more than a predetermined amount (absolute value of the threshold value α) during the unit time.

When determining that the voltage variation amount ΔV is not less than the threshold value α, each module control device 90 increases the set utilization rate Uf by a predetermined ratio (step S108), and returns the process to step S104. That is, each module control device 90 repeats the process of increasing the set utilization rate Uf by a predetermined ratio (for example, 0.5%) every predetermined time (for example, 10 min) until the voltage variation amount ΔV is less than the negative threshold value α in step S106. When the set utilization rate Uf is increased by a predetermined ratio, the target fuel flow rate Fgtag is set to decrease by an amount multiplied by a reciprocal of the predetermined ratio. Accordingly, the power generation efficiency can be improved by supplying less fuel. When determining that the voltage variation amount ΔV is less than the threshold value α in step S106 in the process of repeating the process, each module control device 90 decreases the set utilization rate Uf by the predetermined ratio, that is, returns the set utilization rate to the previous set utilization rate Uf (step S110), and advances the process to step S200.

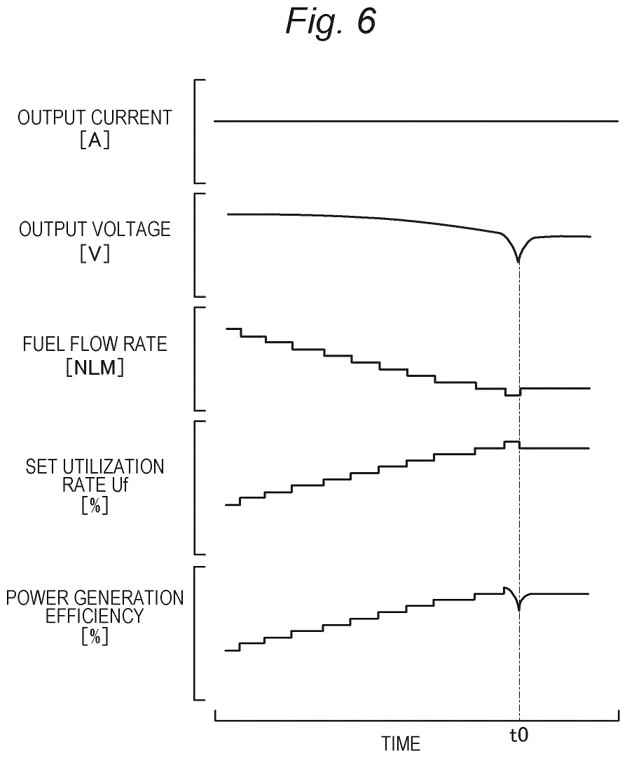

FIG. 6 is an explanatory diagram illustrating temporal changes of the output current I, the output voltage V, the fuel flow rate Fg, and the power generation efficiency when the set utilization rate Uf is increased. As illustrated in the drawing, the set utilization rate Uf is increased by a predetermined ratio every predetermined time while keeping the output current I constant. As a result, the power generation efficiency increases as the set utilization rate Uf increases. On the other hand, when the set utilization rate Uf is excessively increased, a phenomenon occurs in which the output voltage V rapidly decreases due to fuel shortage to the fuel cell stack 21. Therefore, when the voltage variation amount ΔV is less than the negative threshold value α and the output voltage V decreases at a rate exceeding the predetermined amount per unit time (time t0), the increase in the set utilization rate Uf is stopped and the set utilization rate Uf is returned to the previous set utilization rate Uf. As a result, the set utilization rate Uf can be increased as much as possible within a range in which fuel shortage does not occur, and the power generation efficiency can be optimized.

When determining that the current activation is not the first activation but the second or later activation in step S102, the CPU 101 reads the set utilization rate Uf stored in the EEPROM (step S112), and advances the process to step S200.

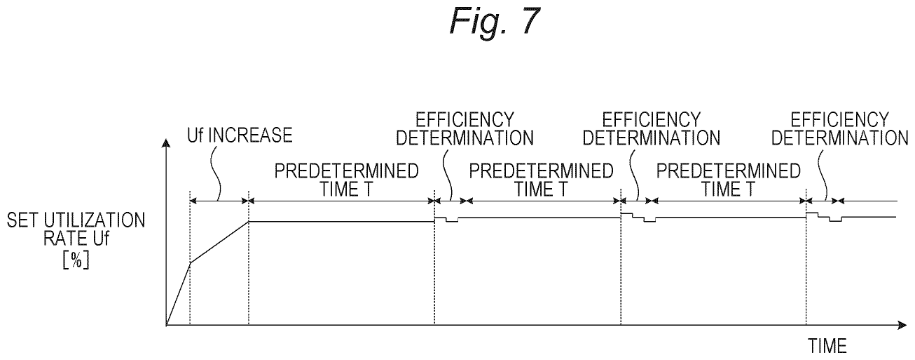

Next, each module control device 90 determines whether the efficiency determination condition is satisfied (step S200). Here, for example, as illustrated in FIG. 7, the efficiency determination condition is a condition that is satisfied when a predetermined time T elapses after execution of the process of increasing the set utilization rate Uf in steps S104 to S108, or when the predetermined time T elapses after execution of the previous efficiency determination. The predetermined time T is a waiting time required until the operation state is stabilized after the set utilization rate Uf is changed. When determining that the efficiency determination condition is not satisfied, each module control device 90 advances the process to step S226.

On the other hand, when determining that the efficiency determination condition is satisfied, each module control device 90 increases the set utilization rate Uf by a predetermined ratio (step S202), and then calculates the power generation efficiency η after the increase in the set utilization rate by the following Equation (1) (step S204). In Equation (1), “V” represents an output voltage, “I” represents an output current, and “Fg” represents a fuel flow rate. “k” is a coefficient. In the present embodiment, the power generation efficiency η is calculated as an average value of a predetermined period (for example, 5 min) after a predetermined time (for example, 5 min) elapses after the set utilization rate Uf is changed.

$$η = ( V \times I ) / ( k \cdot Fg ) \qquad ( 1 )$$

Next, each module control device 90 determines whether the power generation efficiency η before the increase in the set utilization rate has been calculated (step S206). When determining that the power generation efficiency η before the increase in the set utilization rate is not calculated, each module control device 90 returns the set utilization rate to the set utilization rate Uf before the increase (step S208), and calculates the power generation efficiency η before the increase in the set utilization rate by Equation (1) (step S210). Then, each module control device 90 determines whether the power generation efficiency η after the increase in the set utilization rate is equal to or less than the power generation efficiency η before the increase in the set utilization rate (step S212). When determining that the power generation efficiency η after the increase in the set utilization rate is equal to or less than the power generation efficiency η before the increase in the set utilization rate, each module control device 90 advances the process to step S220. On the other hand, when determining that the power generation efficiency η after the increase in the set utilization rate is larger than the power generation efficiency η before the increase in the set utilization rate (step S214), each module control device 90 sets the set utilization rate Uf after the increase in step S202, returns the process to step S202, repeats the process of steps S202 and S204 of increasing the set utilization rate Uf by the predetermined ratio and calculating the power generation efficiency η at that time, and advances the process to step S206. Here, since the power generation efficiency η after the increase in the set utilization rate calculated in the latest step S204 is the power generation efficiency η before the increase in the set utilization rate, it is determined that the power generation efficiency η before the increase in the set utilization rate has been calculated. Next, each module control device 90 determines whether the power generation efficiency η after the increase in the set utilization rate is equal to or less than the power generation efficiency η before the increase in the set utilization rate (step S216). When determining that the power generation efficiency η after the increase in the set utilization rate is larger than the power generation efficiency η before the increase in the set utilization rate, each module control device 90 returns the process to step S202 and repeats the process of steps S202 to S216. That is, each module control device 90 increases the set utilization rate Uf by the predetermined ratio every predetermined time until the power generation efficiency η after the increase in the set utilization rate is equal to or less than the power generation efficiency η before the increase in the set utilization rate. On the other hand, when determining that the power generation efficiency η after the increase in the set utilization rate is equal to or less than the power generation efficiency η before the increase in the set utilization rate, each module control device 90 sets the previous (before increase) set utilization rate Uf (step S218), and advances the process to step S220.

Next, each module control device 90 decreases the set utilization rate Uf by the predetermined ratio (step S220), and then calculates the power generation efficiency η after the decrease in the set utilization rate by Equation (1) (step S222). Subsequently, each module control device 90 determines whether the power generation efficiency η after the decrease in the set utilization rate is equal to or less than the power generation efficiency η before the decrease in the set utilization rate (step S224). When determining that the power generation efficiency η after the decrease in the set utilization rate is larger than the power generation efficiency η before the decrease in the set utilization rate, each module control device 90 returns the process to step S220 and repeats the process of steps S220 to S224. Each module control device 90 decreases the set utilization rate Uf by the predetermined ratio every predetermined time until the power generation efficiency η after the decrease in the set utilization rate is equal to or less than the power generation efficiency η before the decrease in the set utilization rate. On the other hand, when determining that the power generation efficiency η after the decrease in the set utilization rate is equal to or less than the power generation efficiency η before the decrease in the set utilization rate, each module control device 90 sets the previous (before decrease) set utilization rate Uf (step S226), and advances the process to step S228.

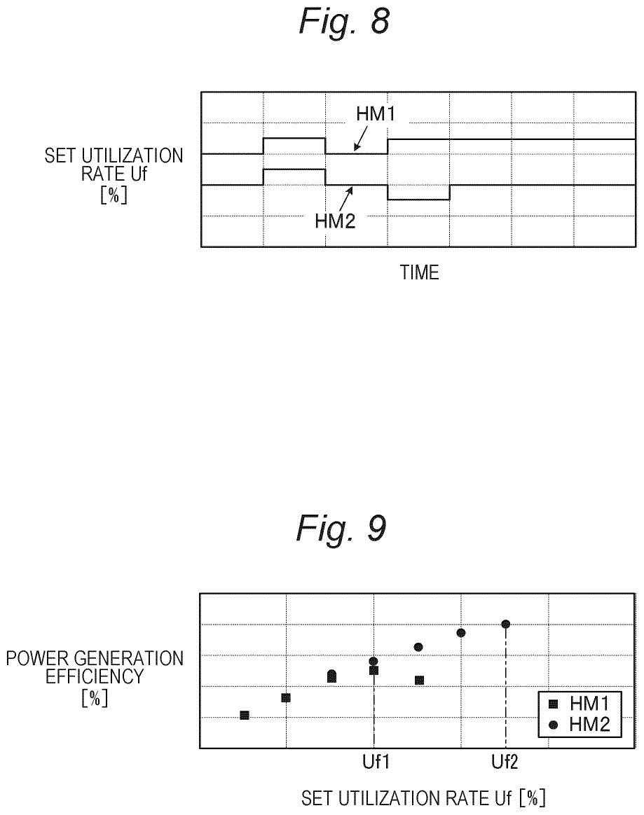

As illustrated in FIG. 8, each module control device 90 changes the set utilization rate Uf for each power generation module 20 (for example, in the drawing, HM1 and HM2) by a predetermined ratio, calculates the power generation efficiency η before and after the change, and causes a transition to the set utilization rate Uf with the higher power generation efficiency η. As a result, as illustrated in FIG. 9, it is possible to find the set utilization rates Uf1 and Uf2 at which the optimum power generation efficiency η is obtained for each power generation module 20 (for example, in the drawing, HM1 and HM2). As a result, the efficiency of the fuel cell system 10 can be further improved. As described above, the fuel flow rate is controlled by setting the target fuel flow rate Fgtag by multiplying the fuel flow rate necessary for power generation by the fuel cell stack 21 by the reciprocal of the set utilization rate Uf (decimal conversion), and performing feedback control based on the deviation between the set target fuel flow rate Fgtag and the fuel flow rate Fg detected by the fuel flow meter 44. Since the detection value of the fuel flow meter 44 usually includes an error, the set utilization rate Uf does not coincide with the actual fuel utilization rate (actual utilization rate). However, by adjusting the set utilization rate Uf so as to obtain the optimum power generation efficiency η for each power generation module 20, the actual utilization rate of each power generation module 20 can be adjusted to be the optimum utilization rate.

Next, each module control device 90 determines whether the operation of the system is stopped (step S228). When determining that the operation of the system is not stopped, each module control device 90 acquires a change amount (voltage variation amount ΔV) per unit time (for example, 300 sec) of the output voltage V detected by the voltage sensor 91 (step S230), and determines whether the acquired voltage variation amount ΔV is less than the negative threshold value α (step S232). When determining that the voltage variation amount ΔV is less than the threshold value α, each module control device 90 determines that fuel shortage occurs in the fuel cell stack 21, decreases the set utilization rate Uf by the predetermined ratio (step S234), and returns the process to step S200. On the other hand, when determining that the voltage variation amount ΔV is not less than the threshold value α, each module control device 90 skips step S234 and returns the process to step S200. Accordingly, when fuel shortage occurs in the fuel cell stack 21 as a result of the transition of the set utilization rate Uf by the efficiency determination, the fuel shortage can be eliminated by decreasing the set utilization rate Uf, and the occurrence of the malfunction of the fuel cell stack 21 due to the fuel shortage can be suppressed.

When determining that the system is stopped in step S228, each module control device 90 stores the current set utilization rate Uf in the EEPROM (step S236), and ends this routine. As a result, when the system is activated next, each module control device 90 determines that the current activation is not the first activation in step S102, and sets the target fuel flow rate Fgtag using the set utilization rate Uf stored in the EEPROM to control the fuel flow rate. Note that the process of steps S104 to S110 is executed at the time of first activation, but may be executed every time activation is performed, or may be executed every time the number of times of activation reaches a predetermined number of times.

In the embodiment described above, the fuel supply system 40 supplies hydrogen gas as fuel gas to the fuel electrode of the fuel cell stack 21, but raw fuel gas such as natural gas or LP gas may be reformed into fuel gas containing hydrogen gas and supplied to the fuel electrode of the fuel cell stack 21. In this case, the fuel supply system may include a gas pump that pumps the raw fuel gas to the branch pipe 41 and a desulfurizer that removes a sulfur component in the raw fuel gas, and may include an evaporator that receives a supply of water (reformed water) into the module case 29 and generates steam, and a reformer that reforms the raw fuel gas into the fuel gas using the steam from the evaporator.

In the above-described embodiment, the fuel cell system 10 includes the plurality of the fuel cell stacks 21 connected in series, but may include a single fuel cell stack 21.

In the embodiment described above, each fuel cell stack 21 performs the power generation operation of generating power by the reaction between hydrogen and oxygen contained in air. However, the fuel cell stack 21 is a reversibly operated solid oxide cell stack, and may include an FC mode in which a power generation operation is executed and an EC mode in which an electrolysis operation in which hydrogen is generated by high-temperature steam electrolysis in a state in which power is supplied from a power supply is executed. As the power source, a system power source, renewable energy such as a solar power generator, a storage battery, or the like can be used.

Although the forms for carrying out the present disclosure have been described with reference to the above embodiments, the present disclosure is not limited to such embodiments at all, and can be carried out in various forms without departing from the gist of the present disclosure.

A first fuel cell system of the present disclosure includes a power generation module including a fuel cell that generates power by receiving a supply of fuel, and a combustion unit that burns unused fuel that is not used in the fuel cell, a fuel supply system that is allowed to adjust a flow rate of fuel to be supplied to the fuel cell, a voltage sensor that detects a voltage of the fuel cell, and a control unit that monitors a voltage detected by the voltage sensor while increasing a fuel utilization rate by decreasing a flow rate of fuel supplied to the fuel cell in a state where a current taken out from the fuel cell is kept constant, and determines a set fuel utilization rate used for an operation of the fuel cell based on a decrease in the voltage detected by the voltage sensor at a rate exceeding a predetermined amount per unit time.

In the first fuel cell system of the present disclosure, the voltage detected by the voltage sensor is monitored while increasing the fuel utilization rate by decreasing the flow rate of the fuel supplied to the fuel cell in a state where the current taken out from the fuel cell is kept constant, and the set fuel utilization rate used for the operation of the fuel cell is determined based on a decrease in the voltage detected by the voltage sensor at a rate exceeding a predetermined amount per unit time. When the fuel shortage occurs in the fuel cell, the voltage of the fuel cell rapidly decreases, and by monitoring this, it is possible to set the fuel utilization rate as high as possible within a range in which the fuel shortage does not occur in the fuel cell. As a result, the efficiency of the fuel cell system can be further improved.

A second fuel cell system of the present disclosure includes a power generation module including a fuel cell that generates power by receiving a supply of fuel, and a combustion unit that combusts unused fuel that is not used in the fuel cell, a fuel supply system that is allowed to adjust a flow rate of fuel supplied to the fuel cell, and a control unit that executes control to change a fuel utilization rate by changing the flow rate of the fuel supplied to the fuel cell, calculate power generation efficiency before and after a change in the fuel utilization rate, compare the power generation efficiency before and after the change, and cause a transition to a fuel utilization rate with a higher power generation efficiency.

The second fuel cell system of the present disclosure executes control to change the fuel utilization rate by changing the flow rate of the fuel to be supplied to the fuel cell, calculate the power generation efficiency before and after the change in the fuel utilization rate, compare the power generation efficiency before and after the change, and cause a transition to the fuel utilization rate having the higher power generation efficiency. By causing a transition to the fuel utilization rate having a higher power generation efficiency, the efficiency of the fuel cell system can be further improved.

The present disclosure is applicable to a manufacturing industry of a fuel cell system.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A fuel cell system comprising:
a power generation module including a fuel cell that generates power by receiving a supply of fuel, and a combustion unit that burns unused fuel that is not used in the fuel cell;
a fuel supply system that is allowed to adjust a flow rate of fuel to be supplied to the fuel cell;
a voltage sensor that detects a voltage of the fuel cell; and
a control unit that monitors a voltage detected by the voltage sensor while increasing a fuel utilization rate by decreasing a flow rate of fuel supplied to the fuel cell in a state where a current taken out from the fuel cell is kept constant, and determines a set fuel utilization rate used for an operation of the fuel cell based on a decrease in the voltage detected by the voltage sensor at a rate exceeding a predetermined amount per unit time.

2. The fuel cell system according to claim 1,
wherein the control unit increases the fuel utilization rate by a predetermined ratio every predetermined time until the voltage detected by the voltage sensor decreases by more than the predetermined amount per unit time, and when the voltage detected by the voltage sensor decreases by more than the predetermined amount per unit time, the control unit decreases the fuel utilization rate by the predetermined ratio to determine the set fuel utilization rate.

3. A fuel cell system comprising:
a power generation module including a fuel cell that generates power by receiving a supply of fuel, and a combustion unit that combusts unused fuel that is not used in the fuel cell;
a fuel supply system that is allowed to adjust a flow rate of fuel supplied to the fuel cell; and
a control unit that executes control to change a fuel utilization rate by changing the flow rate of the fuel supplied to the fuel cell, calculate power generation efficiency before and after a change in the fuel utilization rate, compare the power generation efficiency before and after the change, and cause a transition to a fuel utilization rate with a higher power generation efficiency.

4. The fuel cell system according to claim 3, further comprising:
a voltage sensor that detects a voltage of the fuel cell,
wherein the control unit decreases the fuel utilization rate regardless of the control when the voltage detected by the voltage sensor decreases at a rate exceeding a predetermined amount per unit time.
